(19) United States
(12) Patent Application Publication
(10) Pub. No.: US 2006/0269083 A1
(43) Pub. Date: Nov. 30, 2006

(54) Multi-purpose speaker

(76) Inventor: Shaoming Liang, Jiangmen (CN)

Correspondence Address: Mr. Eric Chan, 42 Pin Oaks Drive, Phoenixville, PA, 19460, US

(21) Appl. No.: 11/134,433

(22) Filed: May 23, 2005

(51) Int. Cl. H04R 3/00

(52) U.S. Cl. 381/111

(57) ABSTRACT

This invention has given birth to a multi-purpose speaker, and this type of speaker contains an external cover, loudspeaker, power supply, microphone, magnified circuit, switch and a volume adjustor. In the front of the resonance cartridge in the loudspeaker is a spotlight. The external cover is composed of a loudspeaker, a handle and a back cover, among which the handle comprises a left and right cover. Both the covers are bolted together, and so are the loudspeaker and the handle, as well as the handle and the back cover. The speaker could be used both as torchlight and speaker after being turned on. Besides, people are also able to use the speaker as an alarming apparatus, radio and recorder, which could be recharged when facing power shortage by giving out shortage indication. In addition, it's structurally simple. Therefore, it is an ideal choice in many situations.

### BACKGROUND OF THE INVENTION

This patent involves a multi-purpose speaker, an invention of portable speaker.

The current speaker comprises an external cover, reproducer, power supply, microphone, magnified circuit and the switch and a volume adjustor. The front of the cover rests the loudspeaker, with a resonance cartridge inside for reflecting the sound. The microphone for collecting sound is installed on the back of the cover, and when the sound enters the microphone, the sound wave shall be changed into electric signal, which shall be transformed to sound wave through the loudspeaker after being magnified by the magnified circuit. The sound wave will then, be reflected and given out by the speaker.

The automated microcomputer speaker, released on Dec. 30th, 1992 and with the patent number CN2126493U, contains a sound collector, power supply, power amplifier, a loudspeaker and calculation amplifier, language proc

The connection exists between the picking-up cartridge and calculation amplifier, the calculation amplifier and language processor, the language processor and the memorizer, the recording and playing controller and language processor, the calculation amplifier and power amplifier, the power amplifier and loudspeaker. The power supply connects the power amplifier, calculation amplifier, language processor and the memorizer respectively. This type of speaker is limitedly functional and thus not easy to use.

### BRIEF SUMMARY OF THE INVENTION

This invention has helped us solve the problems of current speakers, including the singularity of function and inconvenience for carrying, but given birth to a new type of multi-purpose speaker, which is easy to use and has many functions.

The technology scheme is as follows: multi-purpose speaker, including its external cover, loudspeaker, power supply, microphone, magnified circuit, switches and volume adjustor. A spotlight is equipped inside the front cover. The external cover described includes a loudspeaker cartridge, handle and back cover. To be more specific, the handle is covered by two parts, the right and the left side, and the two sides are bolted together. The loudspeaker and the handle, the handle and the back cover, are also joined together by bolts, which has simplified the external cover of the speaker. A space on the back cover has been left for placing volume adjustor. Furthermore, the picking-up cartridge takes the straight shape and a battery cartridge in the handle is also available.

Two arm-brace has been available under the front part of the loudspeaker cartridge, which shall be used to uphold the speaker along with the handle. Besides, a radio and a recorder as well as an annunciator are installed inside the external cover.

The speaker cartridge and its handle are bolted together through the holes on the joining armor plates, which are behind the banding holes on the right and left side of the speaker.

Special effects: the speaker could be used both as torchlight and speaker after being turned on. Besides, people are also able to use the speaker as an alarming apparatus, radio and recorder, which could be recharged when facing power shortage by giving out shortage indication. In addition, it's structurally simple. Therefore, it is an ideal choice in many situations.

### BRIEF DESCRIPTION OF THE DRAWINGS

Drawing 1: the cutaway view of the speaker

Drawing 2: analysis view of the speaker

Drawing 3: right side-viewed drawing

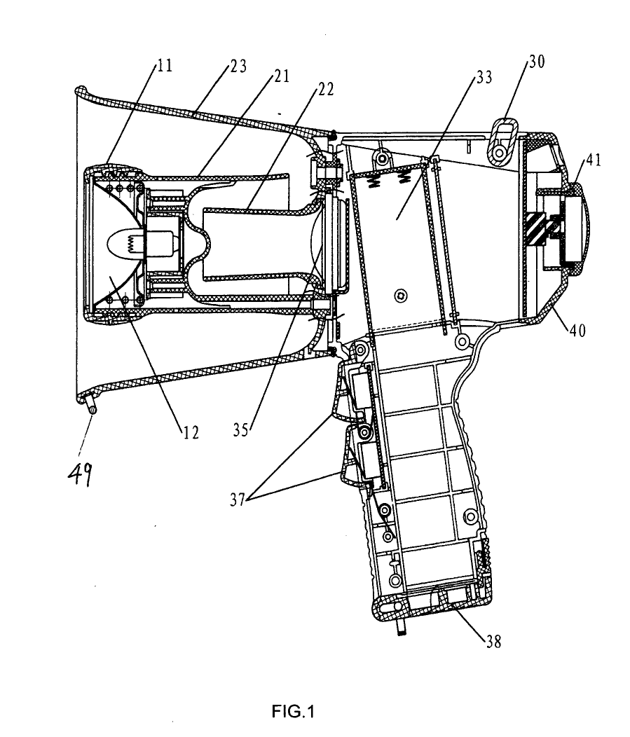

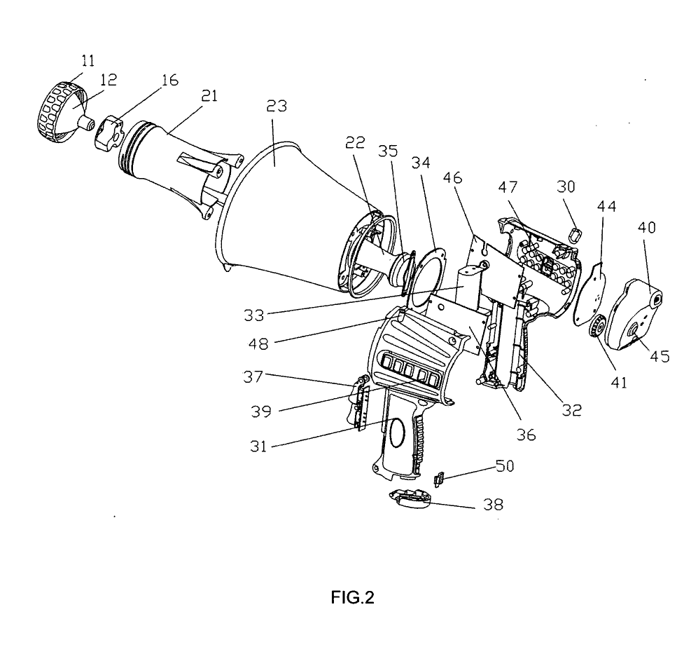

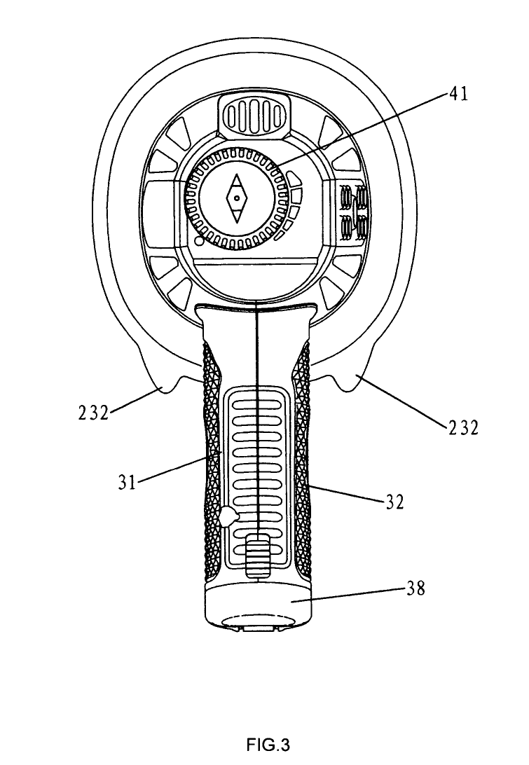

According to the FIG. 11. Screw thread cover 12. Light cup 16. Light pedestal 21. Middle cartridge 22. Internal cartridge 23. Loudspeaker cartridge 231. Hanging ring 232. Arm brace, front hanging ring 30. Back hanging ring 31. Left cover 311. band 32. Right cover 321. band 33. Battery barrel 34. Joining armor metal 35. Loudspeaker 36. Circuit board 37. Switch 38. battery barrel cover 39. button 40. back cover 41. knob 43. microphone pedestal 44. circuit board of the power supply 45. whistle button 46. amplified circuit board 47. alarming button 48. antenna 49. Front hanging ring

### DETAILED DESCRIPTION OF THE INVENTION

Drawing 1 includes a three-dimensional analysis of the implementation of multi-purpose speaker. According to the 1,2 and 3 drawing, the speaker comprises an external cover, loudspeaker 35, circuit board, power supply, microphone, switch 37 and one volume adjustor, among which the external cover is composed of a loudspeaker cartridge 23, left cover 31, right cover 32, and back cover 40. The right and left cover, which are bolted together, collectively form the handle. A volume and illuminating switch 37 are installed on the front of the handle, and in the front of the handle is a loudspeaker cartridge 23 and the back cover 40 is placed at the back of the handle. The back cover is fastened by the bolt built inside the left cover 31 and the right cover 32 and the hole on the rim of the front side of back cover 40. A power supply circuit board 44 is installed in the back cover 40, and the alarming button 45 is fixed on the back cover 40 from inside out, with part of the button exposed out. The recharge socket is built on the power supply circuit board 44, so that recharging from the side of the back cover 40 is made possible. The volume potentiometer is fixed under the power supply circuit board 44, and the volume adjustor 41 is knotted on the potentiometer, thus people can partly adjust the volume by the volume adjusting button placed on the lower side of the back cover 40. The power supply indication light is built on the circuit board 44, with a small part standing out from the back of the back cover 40, and the light will be on when any of these functions are working, including speaking, illuminating, tuning, recording, alarming and whistling. The light is viewed green with normal voltage but red with low voltage. The mini-pedestal 43 projects out above the back cover 40 and a microphone is built inside this pedestal, which shall be used for speaking or recording. A battery barrel 33 is fixed inside the handle, which is composed of the left cover 32 and the right cover 31, and the barrel contains batteries. Between the amplified circuit board 46, which is bolted on the upper side of the right cover 31, and the right cover is the alarming button 47 and this button has been installed from inside out, with part of it projecting out of the right cover 31. One end of the battery cartridge 33 is bolted inside the right cover 32 and fastened the circuit board 46 while the other end is pressed by the left cover 31. The function key 39 of the radio and recorder is built between the left cover 32 and the circuit board 36, which has been bolted on the left cover 32, and the various function keys are fastened from inside out, with part projecting out of the left cover 32. The function keys of the radio is composed of power supply switch, tuning switch and reposition switch while the function keys of the recorder comprises the recording and replaying switches. The antenna 48 of the radio is bolted inside the left cover 32, with the projected part above the left cover 31. Amid the relative place of the front side of both the left cover 31 and the right cover 32 builds band 311 and band 321, whose backside lays the joining armor plate 34 with screw. The left cover 31 and right cover 32 bolt the plate 34. The internal barrel 22 and loudspeaker catridge 23 are connected through their back, with the loudspeaker cartridge 23 pressed by loudspeaker 35. The loudspeaker 35 stays opposite the internal cartridge 22, and is bolted on the back of the loudspeaker 23, and the sound emitted by speaker 35 passes through the internal cartridge 22 to the middle cartridge 21, then reflected by the middle cartridge 21 to the pedestal of the loudspeaker 23 before being reflected out through the loudspeaker 23. The lamp pedestal 16 is bolted on the front of the middle cartridge 21. Light cup 11 is fixed by the screw thread cover 12 in the front of the middle cartridge 21, while between the light cup 11 and the screw thread cover 12 places transparent protecting board, with the bulb pressed by the lamp cup onto the lamp holder 16.

What is claimed is:

1. This multi-purpose speaker includes an external cover, a loudspeaker, power supply, microphone, magnified circuit, switch and a volume adjustor. In the front of the resonance cartridge in the loudspeaker is a spotlight. The external cover is composed of a loudspeaker, a handle and a back cover, among which the handle comprises a left and right cover. Both the covers are bolted together, and so are the loudspeaker and the handle, as well as the handle and the back cover.

2. There is a volume-adjusting button on the back cover and the resonance cartridge is straight. A battery barrel is built inside the handle.

3. According to our specifications in clause 2, there are two holders beneath the loudspeaker. Between the relative place in the front of the left and right cover fixes bands with side holes. And the loudspeaker and the handle are bolted together by the screw through the front of the loudspeaker and the joining armor plate on the back of the two bands. A faucet for recharging is made on the side of the back cover. And on the back cover is a power indicator lamp and the radio circuit is installed under the external cover.
